(19) United States
(12) Patent Application Publication
(10) Pub. No.: US 2021/0003402 A1
(43) Pub. Date: Jan. 7, 2021

(54) MAP INFORMATION COMPARING AND AUXILIARY POSITIONING SYSTEM AND METHOD THEREOF

(71) Applicant: TECO Electric & Machinery Co., Ltd., Taipei City (TW)

(72) Inventors: Chia-Jen LIN, Taipei City (TW); Shih-Chang CHEU, Taipei City (TW); Chun-Chi LAI, Taipei City (TW)

(21) Appl. No.: 16/554,063

(22) Filed: Aug. 28, 2019

(30) Foreign Application Priority Data
Jul. 1, 2019 (TW) 108123036

(51) Int. Cl. G01C 21/30; G01C 21/36; G01S 19/42; G01S 19/25

(52) U.S. Cl. CPC G01C 21/30; G01C 21/367; G01S 19/258; G01S 19/42; G01C 21/3676

(57) ABSTRACT

A map information comparing and auxiliary positioning system set on a mobile platform includes an original map establishing module, a real-time map establishing module, a comparing module and a positioning module. The original map establishing module is utilized to establish an original map information marked with a plurality of original coordinates of a plurality of original feature objects. The real-time map establishing module is utilized to establish a real-time map information marked with a plurality of real-time coordinates of a plurality of real-time feature objects. The comparing module is utilized to compare the plurality of real-time coordinates with the plurality of original coordinates, and further to define the same coordinates as at least one valid reference coordinate. The positioning module is utilized to auxiliary position the mobile platform by using the at least one valid reference coordinate. In addition, a map information comparing and auxiliary positioning method is provided.

This application claims the benefit of Taiwan Patent Application Serial No. 108123036, filed Jul. 1, 2019, the subject matter of which is incorporated herein by reference.

### BACKGROUND OF THE INVENTION

### (1) Field of the Invention

The invention relates to a system and a method, and more particularly to a map information comparing and auxiliary positioning system and a method of the map information comparing and auxiliary positioning system.

### (2) Description of the Prior Art

The positioning technology for robots or automated guided vehicles (AGC) was firstly mentioned in the International Conference on Robotics and Automation in 1999.

With progress in technology, versatile robots or automated guided vehicles have been widely introduced into various fields such as dinning robots, service robots, cleaning robots and automated harbors like Qingdao port in China.

While in positioning the robot or the automated guided vehicle, feature points are generally selected for auxiliary positioning. However, the robot or the automated guided vehicle may capture a mobile feature point for the auxiliary positioning, and thus accuracy of the positioning would be highly questioned. Thereupon, performance of the navigation system for the robot or the automated guided vehicle would be significantly affected.

### SUMMARY OF THE INVENTION

In view of the prior art, while a mobile feature point or an irrelevant feature point is captured, position determination of the robot or the automated guided vehicle would be influenced, and thereby position deviation or the like problem may rise. Accordingly, it is an object of the present invention to provide a map information comparing and auxiliary positioning system for resolving at least one of the aforesaid shortcomings in the art.

In this invention, the map information comparing and auxiliary positioning system, disposed on a mobile platform, includes an original map establishing module, a real-time map establishing module, a comparing module and a positioning module.

The original map establishing module is applied for establishing an original map information marked with a plurality of original positioning reference coordinates standing for a plurality of original feature objects. The real-time map establishing module is applied for establishing an original map information marked with a plurality of original positioning reference coordinates standing for a plurality of original feature objects. The comparing module, electrically coupled with the original map establishing module and the real-time map establishing module, is applied for receiving the original map information and the real-time map information, for comparing the plurality of original positioning reference coordinates with the plurality of real-time positioning reference coordinates, and for defining at least one of the plurality of original positioning reference coordinates the same as one of the plurality of real-time positioning reference coordinates to be at least one valid reference coordinate. The positioning module, electrically coupled with the comparing module and the real-time map establishing module, is used for receiving the at least one valid reference coordinate, and for utilizing the at least one valid reference coordinate to auxiliary position a current position coordinate of the mobile platform in the real-time map information.

In one embodiment of the present invention, the original map establishing module includes an original analysis unit for analyzing the plurality of original feature objects, and the plurality of original feature objects is consisted of a plurality of original boundaries and a plurality of original obstacles.

In one embodiment of the present invention, the real-time map scanning module includes a real-time analysis unit for analyzing the plurality of real-time feature objects, and the plurality of real-time feature objects is consisted of a plurality of real-time boundaries and a plurality of real-time obstacles.

In one embodiment of the present invention, the comparing module includes an obstacle comparing unit for comparing the plurality of original positioning reference coordinates of the plurality of original obstacle positions with the plurality of real-time positioning reference coordinates of the plurality of real-time obstacle positions.

In one embodiment of the present invention, the comparing module further includes a boundary comparing unit for comparing the plurality of original positioning reference coordinates of the plurality of original boundary positions with the plurality of real-time positioning reference coordinates of the plurality of real-time boundary positions.

In one embodiment of the present invention, the comparing module further includes a comparison processing unit electrically coupled with the obstacle comparing unit and the boundary comparing unit for firstly having the obstacle comparing unit to compare the plurality of original positioning reference coordinates of the plurality of original obstacle positions with the plurality of real-time positioning reference coordinates of and the plurality of real-time obstacle positions, and for having the boundary comparing unit to compare the plurality of original positioning reference coordinates of the plurality of original boundary positions with the plurality of real-time positioning reference coordinates of the plurality of real-time boundary positions upon when the plurality of original obstacle feature points is completely different to the plurality of real-time obstacle feature points.

In this invention, the map information comparing and auxiliary positioning method, applied to the map information comparing and auxiliary positioning system of claim 1 for auxiliary positioning the mobile platform, includes Step (a) to Step (d) as follows.

Step (a): Utilize the original map establishing module to establish the original map information marked with the plurality of original positioning reference coordinates representing correspondingly the plurality of original feature objects. Step (b): Utilize the real-time map establishing module to generate the real-time map information in a real time manner, the real-time map information marked with the plurality of real-time positioning reference coordinates representing correspondingly the plurality of real-time feature objects. Step (c): Utilize the comparing module to receive the original map information and the real-time map information, and to compare the plurality of original positioning reference coordinates with the plurality of real-time positioning reference coordinates, so that at least one the same coordinate abstracted from the plurality of original positioning reference coordinates and the plurality of real-time positioning reference coordinates is defined correspondingly as the at least one valid reference coordinate. Finally, Step (d): Utilize the positioning module to receive the at least one valid reference coordinate, and to utilize the at least one valid reference coordinate for auxiliary positioning the current position coordinate for the mobile platform in the real-time map information.

As stated, the map information comparing and auxiliary positioning system provided by this invention compares the original positioning reference coordinates and the real-time positioning reference coordinates to abstract the same coordinates to be further defined as corresponding valid reference coordinates, and then the valid reference coordinates are further utilized to auxiliary position the current position coordinate of the mobile platform.

All these objects are achieved by the map information comparing and auxiliary positioning system and method thereof described below.

### BRIEF DESCRIPTION OF THE DRAWINGS

The present invention will now be specified with reference to its preferred embodiment illustrated in the drawings, in which:

FIG. 1 is a schematic block view of a preferred map information comparing and auxiliary positioning system in accordance with the present invention;

FIG. 2 presents schematically original map information established by the preferred map information comparing and auxiliary positioning system of FIG. 1;

FIG. 3 presents schematically real-time map information established by the preferred map information comparing and auxiliary positioning system of FIG. 1, with respect to FIG. 2;

FIG. 4 demonstrates schematically differences between original positioning reference coordinates (FIG. 2) and real-time positioning reference coordinates (FIG. 3) provided by the preferred map information comparing and auxiliary positioning system of FIG. 1; and

FIG. 5 demonstrates schematically valid reference coordinates defined by the preferred map information comparing and auxiliary positioning system of FIG. 1, with respect to FIG. 2 and FIG. 3.

### DESCRIPTION OF THE PREFERRED EMBODIMENT

The invention disclosed herein is directed to a map information comparing and auxiliary positioning system and method thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

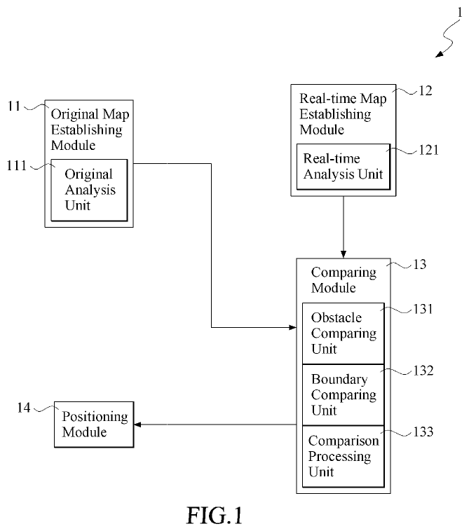

Referring now to FIG. 1, a schematic block view of a preferred map information comparing and auxiliary positioning system 1 in accordance with the present invention is provided. As shown, the map information comparing and auxiliary positioning system 1 includes an original map establishing module 11, a real-time map establishing module 12, a comparing module 13 and a positioning module 14. The comparing module 13 is electrically coupled with the original map establishing module 11, the real-time map establishing module 12 and the positioning module 14.

The original map establishing module 11 includes an original analysis unit 111, the real-time map establishing module 12 includes a real-time analysis unit 121, and the comparing module 13 includes an obstacle comparing unit 131, a boundary comparing unit 132 and a comparison processing unit 133.

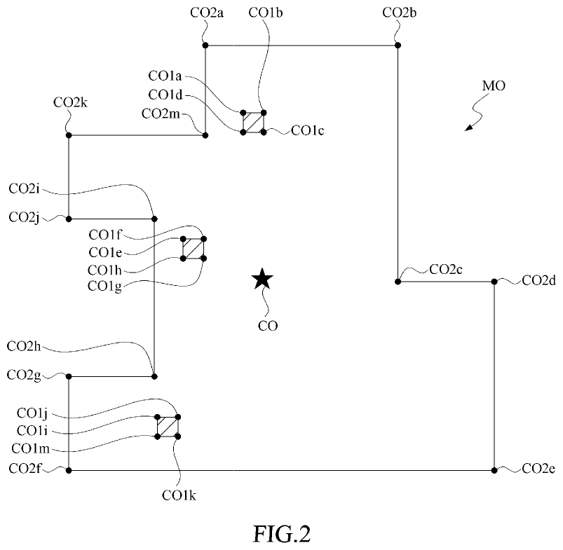

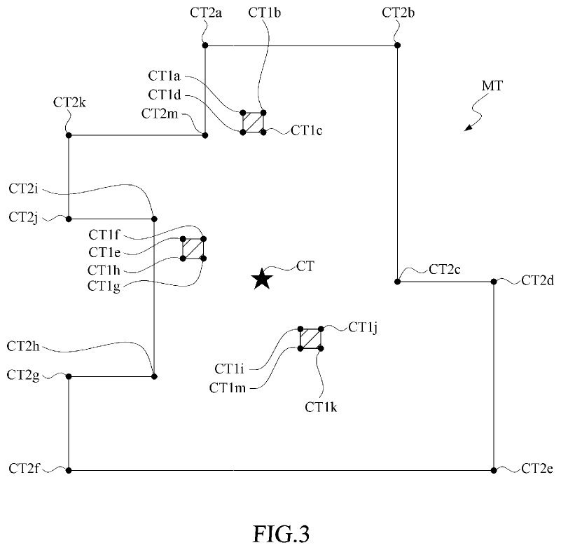

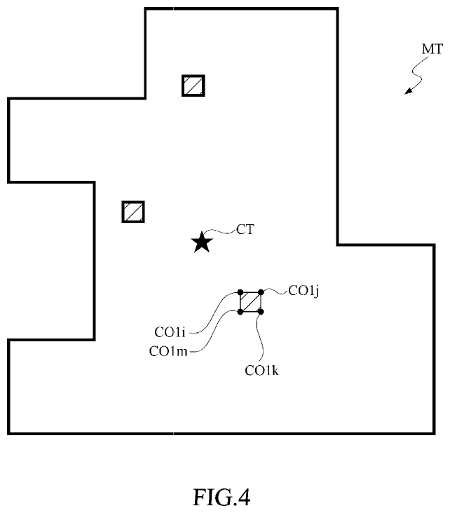

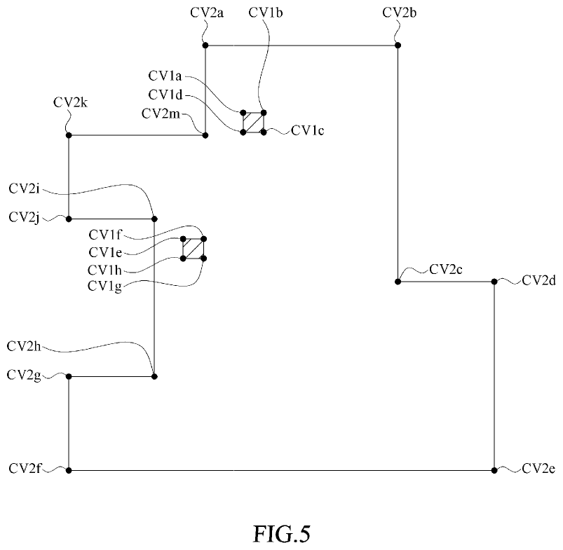

Refer now also to FIG. 2 to FIG. 5; where FIG. 2 presents schematically original map information established by the preferred map information comparing and auxiliary positioning system of FIG. 1, FIG. 3 presents schematically real-time map information established by the preferred map information comparing and auxiliary positioning system of FIG. 1 with respect to FIG. 2, FIG. 4 demonstrates schematically differences between original positioning reference coordinates (FIG. 2) and real-time positioning reference coordinates (FIG. 3) provided by the preferred map information comparing and auxiliary positioning system of FIG. 1, and FIG. 5 demonstrates schematically valid reference coordinates defined by the preferred map information comparing and auxiliary positioning system of FIG. 1 with respect to FIG. 2 and FIG. 3.

Practically, the map information comparing and auxiliary positioning system 1 can be permanently disposed on a mobile platform, where the mobile platform can be a robot, an automated guided vehicle and any the like mobile device whose position needs to be determined.

The original map establishing module 11 is applied for establishing original map information MO marked with a plurality of original positioning reference coordinates. These original positioning reference coordinates stand for a plurality of positions of original feature objects, in which the original feature objects are at least consisted of original obstacles and original boundaries. Thus, the original positioning reference coordinates are consisted of original positioning reference coordinates CO1a, CO1b, CO1c, CO1d, CO1e, CO1f, CO1g, CO1h, CO1i, CO1j, CO1k and CO1m of original obstacles and other original positioning reference coordinates CO2a, CO2b, CO2c, CO2d, CO2e, CO2f, CO2g, CO2h, CO2i, CO2j, CO2k and CO2m of original boundaries. In addition, the original map information MO is marked with an original position coordinate CO standing for the original position of the mobile platform.

In this embodiment, the original positioning reference coordinates can be marked at, but not limited to, the deflection points of all line segments. In another embodiment of the present invention, the original positioning reference coordinates are marked by being separated with the same distance. For example, additional three original positioning reference coordinates are evenly interpolated between the two original positioning reference coordinates CO2a and CO2b of FIG. 2. In other words, every two neighboring original positioning reference coordinates are spaced by the same distance. In a further embodiment of the present invention, a center point of each of the original feature objects is marked as the original positioning reference coordinate.

The real-time map establishing module 12 is applied for generating real-time map information MT in a real time manner, and the real-time map information MT is marked with a plurality of real-time positioning reference coordinates. The real-time feature objects are consisted at least of real-time obstacles and real-time boundaries. Hence, the real-time positioning reference coordinates can be consisted of real-time positioning reference coordinates CT1a, CT1b, CT1c, CT1d, CT1e, CT1f, CT1g, CT1h, CT1i, CT1j, CT1k and CT1m of the real-time obstacles and real-time positioning reference coordinates CT2a, CT2b, CT2c, CT2d, CT2e, CT2f, CT2g, CT2h, CT2i, CT2j, CT2k and CT2m of the real-time boundaries. In addition, the real-time map information MT is marked with a real-time position coordinate CT standing for the real-time position of the mobile platform. The criteria to determine the coordinate points for the real-time positioning reference coordinates are the same as that for the original positioning reference coordinates, and thus details thereabout are omitted herein.

The comparing module 13, electrically coupled with the original map establishing module 11 and the real-time map establishing module 12, is applied for receiving the original map information MO and the real-time map information MT, and for comparing the original positioning reference coordinates CO1a, CO1b, CO1c, CO1d, CO1e, CO1f, CO1g, CO1h, CO1i, CO1j, CO1k, CO1m, CO2a, CO2b, CO2c, CO2d, CO2e, CO2f, CO2g, CO2h, CO2i, CO2j, CO2k and CO2m with the real-time positioning reference coordinates CT1a, CT1b, CT1c, CT1d, CT1e, CT1f, CT1g, CT1h, CT1i, CT1j, CT1k, CT1m, CT2a, CT2b, CT2c, CT2d, CT2e, CT2f, CT2g, CT2h, CT2i, CT2j, CT2k and CT2m, respectively.

The comparing module 13 would define the same coordinates from the above coordinates to be valid reference coordinates. As shown, the real-time positioning reference coordinates CT1i, CT1j, CT1k and CT1m in the real-time map information MT are apparently different to the corresponding original positioning reference coordinates CO1i, CO1j, CO1k and CO1m in the original map information MO. In other words, the real-time feature object stood by the real-time positioning reference coordinates CT1i, CT1j, CT1k and CT1m could be an object moved from the original feature object stood by the original positioning reference coordinate CO1i, CO1j, CO1k and CO1m, or from another object. It can be sure that, while the original map establishing module 11 is establishing the original map information MO, the real-time feature object does not exist. Thus, the comparing module 13 will not refer to the real-time positioning reference coordinates CT1i, CT1j, CT1k and CT1m.

The resting real-time positioning reference coordinates CT1a, CT1b, CT1c, CT1d, CT1e, CT1f, CT1g, CT1h, CT2a, CT2b, CT2c, CT2d, CT2e, CT2f, CT2g, CT2h, CT2i, CT2j, CT2k and CT2m are the same as the original positioning reference coordinates CO1a, CO1b, CO1c, CO1d, CO1e, CO1f, CO1g, CO1h, CO2a, CO2b CO2c, CO2d, CO2e, CO2f, CO2g, CO2h, CO2i, CO2j, CO2k and CO2m, respectively. Thus, the comparing module 13 would define the aforesaid coordinates as valid reference coordinates CV1a, CV1b, CV1c, CV1d, CV1e, CV1f, CV1g, CV1h, CV2a, CV2b, CV2c, CV2d, CV2e, CV2f, CV2g, CV2h, CV2i, CV2j, CV2k and CV2m.

In this embodiment, the original analysis unit 111 would analyze the original feature object, and determine whether the original feature object is an original obstacle or an original boundary. Similarly, the real-time analysis unit 121 is also used for analyzing and determining whether the real-time feature object is a real-time obstacle or a real-time boundary.

Thus, the obstacle comparing unit 131 in the comparing module 13 would firstly compare whether the original positioning reference coordinates CO1a, CO1b, CO1c, CO1d, CO1e, CO1f, CO1g, CO1h, CO1i, CO1j, CO1k and CO1m of the original obstacle positions are the same as the corresponding real-time positioning reference coordinates CT1a, CT1b, CT1c, CT1d, CT1e, CT1f, CT1g, CT1h, CT1i, CT1j, CT1k and CT1m of the real-time obstacle positions. In this embodiment, those presenting the same coordinates are defined as valid reference coordinates CV1a, CV1b, CV1c, CV1d, CV1e, CV1f, CV1g and CV1h. In this embodiment, since at least one valid reference coordinate is located by the obstacle comparing unit 131, thus the comparison processing unit 133 would not be activated.

In the case that the obstacle comparing unit 131 does not locate any two coordinates having the same coordinate, thus no valid reference coordinate is defined, and the comparison processing unit 133 would drive the boundary comparing unit 132 to further proceed the comparison between the original positioning reference coordinates CO2a, CO2b CO2c, CO2d, CO2e, CO2f, CO2g, CO2h, CO2i, CO2j, CO2k and CO2m of the original boundary positions and the real-time positioning reference coordinates CT2a, CT2b, CT2c, CT2d, CT2e, CT2f, CT2g, CT2h, CT2i, CT2j, CT2k and CT2m of the real-time boundary positions. Similarly, if any two coordinates are the same, the boundary comparing unit 132 would define those with the same coordinates as the valid reference coordinates, such as the valid reference coordinates CV2a, CV2b, CV2c, CV2d, CV2e, CV2f, CV2g, CV2h, CV2i, CV2j, CV2k and CV2m.

No matter whether the original boundaries or the real-time boundaries present, associate computations are big. Thus, in this embodiment, those original obstacles and real-time obstacles that need less computation are firstly compared. In the case that no valid reference coordinate is defined, then those original obstacles and real-time obstacles that need more computation are compared. Thereupon, computation resources can be effectively utilized so as to enhance system performance of the map information comparing and auxiliary positioning system 1.

Those foregoing valid reference coordinates are denoted by corresponding bold black lines shown in FIG. 4.

The positioning module 14, electrically coupled with the comparing module 13 and the real-time map establishing module 12, is applied for receiving the valid reference coordinates CV1a, CV1b, CV1c, CV1d, CV1e, CV1f, CV1g, CV1h, CV2a, CV2b, CV2c, CV2d, CV2e, CV2f, CV2g, CV2h, CV2i, CV2j, CV2k and CV2m, and accordingly for auxiliary positioning a current position coordinate of the mobile platform in the real-time map information TM. It is quite possible that the real-time position coordinate CT would be corrected, or that the real-time position coordinate CT is the current position coordinate.

In another aspect of the present invention, a preferred map information comparing and auxiliary positioning method is provided to the map information comparing and auxiliary positioning system 1 of FIG. 1. This method includes Steps S101 to S104 as follows.

Step S101: The original map establishing module is introduced to establish the original map information, and therefore to mark the original map information with a plurality of the original positioning reference coordinates representing corresponding original feature objects.

Step S102: The real-time map establishing module is utilized to generate the real-time map information in a real time manner, and the real-time map information marked with a plurality of the real-time positioning reference coordinates representing corresponding real-time feature objects.

Step S103: The comparing module is used to receive the original map information and the real-time map information, and to compare the plurality of original positioning reference coordinates with the plurality of real-time positioning reference coordinates, so that at least one the same coordinate abstracted from the plurality of original positioning reference coordinates and the plurality of real-time positioning reference coordinates is defined correspondingly as the at least one valid reference coordinate.

Step S104: The positioning module is used to receive the at least one valid reference coordinate, and to utilize the at least one valid reference coordinate for auxiliary positioning the current position coordinate for the mobile platform in the real-time map information.

In Step S101, the original map establishing module 11 of FIG. 1 is applied to establish the original map information MO shown in FIG. 2.

In Step S102, the real-time map establishing module 12 of FIG. 1 is applied to generate the real-time map information MT shown in FIG. 3.

In Step S103, the comparing module 13 of FIG. 1 is applied to perform comparison shown in FIG. 4.

In Step S104, the positioning module 14 of FIG. 1 and the valid reference coordinate of FIG. 5 are introduced to auxiliary position the current position coordinate of the mobile platform.

In summary, the map information comparing and auxiliary positioning system and the associated method provided by this invention utilize the comparing module to compare the original positioning reference coordinates with the real-time positioning reference coordinates, and define the valid reference coordinates for those aforesaid coordinates presenting the same coordinates. Then, the positioning module is introduced to use the valid reference coordinates for auxiliary positioning the current position coordinate of the mobile platform. In comparison with the prior art, the present invention can filter the mobile object effectively, so that the correct coordinate point can be captured to be the auxiliary position point. Thereupon, the positioning error can be avoided, and thus the system performance can be ensured.

While the present invention has been particularly shown and described with reference to a preferred embodiment, it will be understood by those skilled in the art that various changes in form and detail may be without departing from the spirit and scope of the present invention.

What is claimed is:

1. A map information comparing and auxiliary positioning system, disposed on a mobile platform, and comprising:
an original map establishing module, applied for establishing an original map information marked with a plurality of original positioning reference coordinates standing for a plurality of original feature objects;
a real-time map establishing module, applied for establishing a real-time map information marked with a plurality of real-time positioning reference coordinates standing for a plurality of real-time feature objects;
a comparing module, electrically coupled with the original map establishing module and the real-time map establishing module, applied for receiving the original map information and the real-time map information, for comparing the plurality of original positioning reference coordinates with the plurality of real-time positioning reference coordinates, and for defining at least one of the plurality of original positioning reference coordinates the same as one of the plurality of real-time positioning reference coordinates to be at least one valid reference coordinate; and
a positioning module, electrically coupled with the comparing module and the real-time map establishing module, applied for receiving the at least one valid reference coordinate, and for utilizing the at least one valid reference coordinate to auxiliary position a current position coordinate of the mobile platform in the real-time map information.

2. The map information comparing and auxiliary positioning system of claim 1, wherein the original map establishing module includes an original analysis unit for analyzing the plurality of original feature objects, and the plurality of original feature objects is consisted of a plurality of original boundaries and a plurality of original obstacles.

3. The map information comparing and auxiliary positioning system of claim 2, wherein the real-time map scanning module includes a real-time analysis unit for analyzing the plurality of real-time feature objects, and the plurality of real-time feature objects is consisted of a plurality of real-time boundaries and a plurality of real-time obstacles.

4. The map information comparing and auxiliary positioning system of claim 3, wherein the comparing module includes an obstacle comparing unit for comparing the plurality of original positioning reference coordinates of the plurality of original obstacle positions with the plurality of real-time positioning reference coordinates of the plurality of real-time obstacle positions.

5. The map information comparing and auxiliary positioning system of claim 4, wherein the comparing module further includes a boundary comparing unit for comparing the plurality of original positioning reference coordinates of the plurality of original boundary positions with the plurality of real-time positioning reference coordinates of the plurality of real-time boundary positions.

6. The map information comparing and auxiliary positioning system of claim 5, wherein the comparing module further includes a comparison processing unit electrically coupled with the obstacle comparing unit and the boundary comparing unit for firstly having the obstacle comparing unit to compare the plurality of original positioning reference coordinates of the plurality of original obstacle positions with the plurality of real-time positioning reference coordinates of and the plurality of real-time obstacle positions, and for having the boundary comparing unit to compare the plurality of original positioning reference coordinates of the plurality of original boundary positions with the plurality of real-time positioning reference coordinates of the plurality of real-time boundary positions upon when the plurality of original obstacle feature points is completely different to the plurality of real-time obstacle feature points.

7. A map information comparing and auxiliary positioning method, applied to the map information comparing and auxiliary positioning system of claim 1 for auxiliary positioning the mobile platform, the map information comparing and auxiliary positioning method comprising the steps of:
(a) utilizing the original map establishing module to establish the original map information marked with the plurality of original positioning reference coordinates representing correspondingly the plurality of original feature objects;
(b) utilizing the real-time map establishing module to generate the real-time map information in a real time manner, the real-time map information marked with the plurality of real-time positioning reference coordinates representing correspondingly the plurality of real-time feature objects;
(c) utilizing the comparing module to receive the original map information and the real-time map information, and to compare the plurality of original positioning reference coordinates with the plurality of real-time positioning reference coordinates, so that at least one the same coordinate abstracted from the plurality of original positioning reference coordinates and the plurality of real-time positioning reference coordinates is defined correspondingly as the at least one valid reference coordinate; and
(d) utilizing the positioning module to receive the at least one valid reference coordinate, and to utilize the at least one valid reference coordinate for auxiliary positioning the current position coordinate for the mobile platform in the real-time map information.
